(19) United States
(12) Patent Application Publication
(10) Pub. No.: US 2022/0222081 A1
(43) Pub. Date: Jul. 14, 2022

(54) VECTORIZED SORTED-SET INTERSECTION USING CONFLICT-DETECTION INSTRUCTIONS OPTIMIZED FOR SMALL UNPADDED ORDERED SETS

(71) Applicant: Oracle International Corporation, Redwood Shores, CA (US)

(72) Inventors: Benjamin Schlegel, Merced, CA (US); Matthias Brantner, Sunnyvale, CA (US); Hassan Chafi, San Mateo, CA (US)

(21) Appl. No.: 17/148,951

(22) Filed: Jan. 14, 2021

(51) Int. Cl. G06F 9/38; G06F 9/30; G06F 9/345

(52) U.S. Cl. CPC G06F 9/3887; G06F 9/30123; G06F 9/30043; G06F 9/345; G06F 9/3859; G06F 9/3013

(57) ABSTRACT

A method includes determining, whether: a first case is applicable, in which a first number of values of a first dataset and a second number of values of a second dataset total less than or equal to a third number of values of a register; a second case is applicable, in which the first and second numbers total more than the third number, and the first or second number is less than or equal to half of the third number; or a third case is applicable, in which the first and second numbers total more than the third number, and each of the first and second numbers is greater than half of the third number. In response to the determining, the method includes selectively loading to the register a first portion of the first dataset and a second portion of the second dataset, and performing conflict-detection for identifying one or more common values in the register loaded with the first portion and the second portion.

### FIELD OF THE DISCLOSURE

The present disclosure relates to efficiently determining intersection between sets of data or values.

### BACKGROUND

Set intersection is a fundamental operation in query processing in the area of databases and information retrieval, and has a great range of applications. In many applications, an intersection algorithm is executed frequently and should have a high throughput or low latency or both in order to provide fast results to a user, for instance. Multi-keyword queries in search engines, for example, intersect keyword document ID sets to obtain a set of documents that contain given keywords. Similarly, graph engines intersect edge sets of two nodes to obtain common neighbor nodes, for example, to determine common friends of two persons in a social graph. This is a costly operation that is executed often by social networking service providers.

Various intersection algorithms and other techniques have been developed to help optimize set intersection operations. Vectorized set intersection algorithms provide techniques for comparing multiple values K of one set with multiple values K of another set in each iteration, instead of comparing only one value of each set in each iteration, as in scalar intersection algorithms. Industry and academia have provided various vectorized set intersection algorithms, however, many of these algorithms rely on assumptions, such as: large cardinality of the sets being intersected, e.g., the sets have hundreds or thousands of values or more; and the sets being intersected can be padded so that the number of values in a set is a multiple of K. These assumptions, however, are not always true.

In many real-world applications, the cardinality of sets is rather small. Edge sets in graph datasets often have small cardinality being close to the number of values per vector K. Further, even sets with large cardinality are often transformed or segmented into sets with small cardinality, which is a technique that helps to reduce the number of comparisons required during intersection and/or to allow multi-threaded intersection of two sets. Hence, it is desirable to further improve and help optimize vectorized set intersection algorithms for small sets.

Padding arrays is a common technique, which helps to enable processing of array values via Single Instruction, Multiple Data (SIMD) instructions. Padding arrays generally involves adding dummy values to a beginning or end of the array, and configuring the vectorized algorithm to ignore the dummy values. For the storage of sets, padded sets may be acceptable when the set cardinality is large. For example, padding a set that has 1013 values with 11 dummy values to reach 1024 values may generally be acceptable. However, in applications that hold many small sets, padding becomes more problematic. Padding small sets in some cases may double the memory required for storing the sets. This is not acceptable in applications like graph databases or in-memory databases where memory is precious. Furthermore, set segmentation may not allow padding the subsets when an index used for segmentation is separate from the set that is divided into subsets/segments, for example.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates pseudocode for a vectorized sorted-set intersection algorithm according to an embodiment;

FIG. 2 illustrates pseudocode for a vectorized sorted-set intersection algorithm according to an embodiment;

FIG. 3 illustrates pseudocode for a vectorized sorted-set intersection algorithm according to an embodiment;

FIG. 4 illustrates pseudocode for a vectorized sorted-set intersection algorithm according to an embodiment;

FIG. 5 is a flow diagram of example dataset intersection techniques, according to an embodiment;

FIG. 6 illustrates a graph depicting performance comparison of dataset intersection techniques disclosed herein and other techniques;

FIG. 7 is a block diagram that illustrates a computing system upon which an embodiment may be implemented; and

FIG. 8 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present disclosure. It will be apparent, however, that the present disclosure may be practiced without each and every of these specific details. In other instances, well-known structures and devices are shown in block diagram form in order to avoid unnecessarily obscuring the present disclosure.

General Overview

Dataset intersection techniques and algorithms disclosed herein improve upon existing set intersection algorithms, in particular, in better performance on small, unpadded datasets, and without performance penalties for processing larger datasets. This disclosure describes a vectorized merge-based sorted-set intersection algorithm that exploits conflict-detection SIMD instructions and is optimized for small, unpadded sets. The vectorized intersection algorithm is fully vectorized, i.e., all loops of the algorithm are vectorized, with no sequential or scalar parts.

Further, the vectorized intersection algorithm makes use of all comparisons of conflict-detection-based all-to-all comparisons even when one set has values less than half a vector register of size K. More particularly, the disclosed algorithm is configured to fill the entire vector register with values from datasets and performs conflict-detection SIMD instructions on the entire vector. In contrast, other intersection algorithms are known to limit the number of values from a set to a certain number, e.g., K/2, and as a result, when one set has less than K/2 values and another set has more than K/2 values, the entire vector of K values is not filled, and some comparisons of the conflict-detection instruction are considered to be wasted.

The disclosed vectorized intersection algorithm employs a compensation technique to reduce data and control dependencies in loops. The algorithm removes from a result set, outside a loop, potentially wrong common values that are produced when an end of unpadded sets is reached within the loop.

The disclosed vectorized intersection algorithm also helps to minimize vector load operations when intersecting small sets or in one or more iterations when intersecting larger sets. For instance, the present algorithm loads a first smaller set once into the vector, and loads portions of a second larger set into the vector register in one or more iterations. In contrast, other intersection algorithms are known to repeatedly load values from both sets in each iteration.

The following disclosure describes novel, fully vectorized intersection algorithms, including: a loop-free algorithm for intersecting unpadded sets that fit together into one vector of size K; an algorithm for intersecting two unpadded sets where one set has less or exactly the number of values that fit in half of a vector and the other set has an arbitrary length; and an algorithm for intersecting two unpadded sets where both sets have each more than K/2 values.

Further details and potential advantages of the disclosed vectorized intersection algorithm include using masked and adjusted loads to move set values into vector registers, using a strategy function that selects the best fully vectorized intersection algorithm based on a length of unpadded input sets, native support of 32-bit and 64-bit integer values, and techniques to store unpadded sets with minimal, constant space overhead to allow processing the sets via the disclosed vectorized intersection algorithms.

Sorted-Set Intersection Overview

The intersection of two or more datasets returns a result set that contains all common elements from the two or more sets. For example, the intersection of set A {3, 1, 2, 0} and set B {4, 3, 5, 1, 2} results set C {1, 2, 3}, where ‘1’, ‘2’ and ‘3’ are common elements from sets A and B. A sorted-set intersection is the intersection of two or more sets that are sorted or ordered. For example, an intersection of sorted set A {0, 1, 2, 3} and sorted set B {1, 2, 3, 4, 5} is a sorted-set intersection.

Algorithms that perform set intersections usually require iteratively comparing each value from the inputs sets and returning the values that are equal. Thus, many existing algorithms focus on reducing the number of comparisons to improve performance. A scalar sorted-set intersection approach is one such approach that tries to reduce the number of comparisons to improve sorted-set intersection performance.

Conflict-Detection SIMD Instruction Overview

SIMD architectures allow computers with multiple processing elements to simultaneously perform the same operation on multiple data points. SIMD architectures may perform “vertical” instructions, where corresponding elements in separate operands are operated upon in parallel and independently, or “horizontal” instructions, where operations are performed across the elements of a SIMD register.

Horizontal SIMD instructions possess a subclass of conflict-detection SIMD instructions that finds values in an input vector that appear twice or more. The instruction then creates a vector that stores the values that appear twice or more as well as the locations of the duplicate values. The VPCONFLICTD instruction is one example for such instructions.

SIMD instructions allow the execution of the same operation on multiple data elements at once. In an embodiment, values of two or more sorted sets are loaded into a single vector so that conflict-detection SIMD instructions are applied on the vector in order to find the common values within the two or more sorted sets.

An improvement caused by the approach of using conflict-detection SIMD instructions to perform sorted-set intersection includes fewer iterations compared to scalar sorted-set intersection algorithms and, due to the all-to-all comparison of values via SIMD comparison instructions, fewer number of comparisons of values in each sorted set.

AVX-512 Instruction Overview

A vectorized sort-set intersection algorithm that uses conflict-detection SIMD instructions may be used to perform sort-set intersection. In some embodiments, the vectorized sorted-set intersection algorithm is performed on CPUs that support SIMD instructions sets that include conflict-detection SIMD instructions. In one embodiment, the vectorized sorted-set algorithm is performed on CPUs that support an AVX-512 SIMD instruction set.

AVX-512 is a SIMD instruction set introduced by the INTEL CORPORATION. The AVX-512 SIMD instruction set has 512-bit vector operation capabilities. 512-bit specifically refers to the width of the register which sets the parameters for how much data a set of instructions can operate on at a time. For example, a vectorized sorted-set intersection algorithm that uses the AVX-512 SIMD instruction set may operate on eight 64-bit integers, or sixteen 32-bit integers within 512-bit vectors at a time. Thus, a vectorized sort-set intersection algorithm that uses an AVX-512 SIMD instruction set may natively support 32-bit and 64-bit integer values.

The _mm512_mask_loadu_epi32 AVX-512 SIMD instruction may be used to load values from memory and combine them with values from another vector to create a new vector. For example, the _mm512_mask_loadu_epi32 instruction may be used to create a vector that holds values from two or more input sorted sets.

The _mm512_conflict_epi32 AVX-512 SIMD instruction is a conflict-detection instruction that may be used to identify values in a single input vector register that appear more than once. The instruction may also be used to create a result vector that stores the values appearing more than once and the locations of the duplicate values. Thus, the _mm512_conflict_epi32 instruction may be used to identify common values common values (i.e., the intersection) within two or more input sorted sets. For example, in a vector holding 8 distinct values from a first sorted set and 8 distinct values from a second sorted set, the _mm512_conflict_epi32 conflict-detection instruction may be applied to the vector to identify all common values between the 8 distinct values from the first sorted set and the 8 distinct values from the second sorted set. In this example, the conflict instruction operates on a single vector to identify common values, in contrast to receiving two vectors and identifying common values between the two vectors.

The _mm512_mask_compressstoreu_epi32 AVX-512 SIMD instruction may be used to write back a vector's values into memory. Specifically, the instruction takes a vector and a bitmask as inputs and writes back into memory the vector's values that have bits set in the input bitmask. The values that are written back into memory may be stored contiguously in memory.

The following discussion describes embodiments that may use these instructions in sorted-set intersection algorithms that are significantly faster compared to other vectorized and scalar intersection algorithms. The sorted-set intersection algorithms are used in the following cases to intersect two sets fitting together in one vector, intersect two sets where one set fits in half of a vector, and intersect two sets where each set is larger than half of a vector.

For purposes of illustration, examples of vectorized sorted-set intersection algorithms are described in relation to intersecting two input sets. However, it should be understood that any number of input sorted sets can be intersected. In some embodiments, the vectorized sorted-set intersection algorithm takes two or more input sorted sets represented by two or more arguments. Generally herein, an argument out holds a result set, and the example algorithms find common values within a first set s1 and a second set s2 and writes the common values back into the result set. A vector width is represented by the value of K.

Vectorized sorted-set intersection algorithms disclosed herein generally iterate over sorted sets in a certain step size. In each iteration, the algorithm compares n number of values from a first sorted set with m number of values from a second sorted set, where n+m=K. The values of n and m may depend on the domain and number of values of both sorted sets. For example, if the domain of one sorted set is much larger than the domain of the second sorted set, then n should be greater than m.

Intersecting Two Sets Fitting Together in One Vector

According to an embodiment, the sorted-set intersection algorithm handles, and is invoked for, intersections where both sets fit into one vector. The sets may have a different size, for example, when a single vector holds 16 values, one set may have two values while the other set may have up to 14 values. The sum of both sets does not need to be the same as the size of the vector. In this embodiment, the algorithm has four main phases: 1) loading a first set via an unaligned load instruction into a vector (val); 2) loading a second set via an unaligned, masked load instruction into the vector directly before the values from the first set and without overwriting the values from the first set; 3) finding conflicts in the vector via a conflict-detection instruction and masking-out potential invalid conflicts when both sets together have fewer values than a single vector; and 4) writing back values for which a conflict has been found via a compress-and-store instruction. In this embodiment, the algorithm does not require any loop and therefore has no control dependencies.

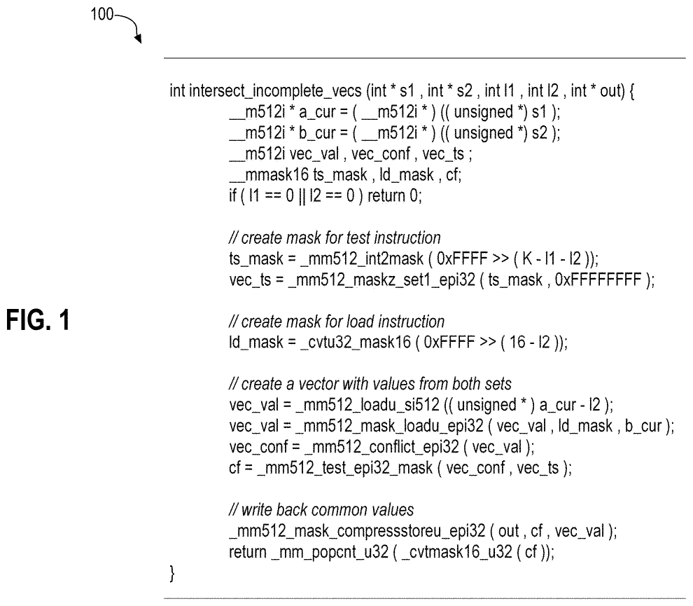

FIG. 1 illustrates pseudocode for an example vectorized sorted-set intersection algorithm for intersecting two sets having together K values or less. The example algorithm is implemented as an intersect incomplete vecs( ) function, which takes arguments or parameters s1, s2, 11, 12, and out. Argument s1 represents or holds values of a first set. Argument s2 represents or holds values of a second set. Arguments l1 and l2 specify or hold lengths of the sets s1 and s2, respectively. Argument out represents a result set that contains a number of common values of sets s1 and s2. In an example, argument out is a pointer to an array where the output should be written into memory.

In the intersect incomplete vecs function, a_cur and b_cur are pointers to current vectors of the first sorted input set s1 and the second sorted input set s2, respectively. The variable vec_val represents a single vector register that receives input from the first and second input sets. The function checks whether either one of the input sets is empty, in which case the result set is also empty, and thus the function returns 0.

When both input sets are non-empty, the function sets up variables ts_mask, vec_ts, and ld_mask. The function uses a mask ld_mask to load the second set without overwriting the values of the first set. A mask ts_mask holds K bits where a first number of bits (the first l1+l2 bits) are set to one (0xFFFF), and all other bits are zero (0xFFFF>>(K−l1−l2)). The one bits of ts_mask mark valid values in vector vec_val, which holds the values of both sets. The variable vec_ts is a vector with the mask ts_mask replicated to all of its values. The vector vec_ts holds value 0xFFFFFFFF and the function uses vec_ts to mask out potential invalid conflicts before writing values into the result set. Invalid conflicts arise, for instance, when the number of remaining values in the sets are together less than K, in which case the vector may be loaded with some invalid or garbage values, which should be disregarded before writing back results.

After setting up the variables, the function loads the first and second sets via instruction _mm512_loadu_si512 and instruction _mm512_mask_loadu_epi32 into the vector vec_val. In this example, the instruction _mm512_loadu_si512 loads values from the first set into the vector vec_val, but with the values from the first set shifted by 12 values so that the first 12 values in the vector are available for values of the second set. The instruction _mm512_mask_loadu_epi32 is a mask load that specifies the existing vector (vec_val), values in the vector to keep/not overwrite via the use of ld_mask, and identifies an address from which to load (b_cur). The mask load instruction loads the appropriate 12 values from the second set into the first 12 values of the vector. These load and mask-load instructions thereby load into the vector vec_val values from the first set right after values from the second set.

The function finds conflicts in vec_val via instruction _mm512_conflict_epi32. A conflict mask cf holds bits set to one for conflicting values obtained via instruction _mm512_test_epi32 mask where vec_ts is passed as a second parameter. The function writes out common values in both sets via instruction _mm512_mask_compressstoreu_epi32, and obtains a number of common values via a population count instruction on the mask cf.

Intersecting Two Sets where One Set Fits in Half of a Vector

According to an embodiment, the sorted-set intersection algorithm handles, and is invoked for, intersections where both sets do not fit into one vector, but one set has less than or exactly as many values as half of the vector. For example, a vector register has 16 values (K=16), a first set has 20 values (more than K/2 values), and a second set has 5 values (K/2 values or less). In this example, the first and second sets together have 25 values and would not fit into the vector of 16 values, and the second set has 5 values, which is less than or equal to 8 or K/2 values.

In this embodiment, the algorithm has three main phases: 1) loading the second set, i.e., the smaller set, with an unaligned load instruction into a vector val; 2) iterating over all values of the first set with a step size of s=K−|S2|, where |S2| is the cardinality or length l2 of the second set; and 3) removing from the result set invalid values, which have been potentially loaded in a last iteration and for which conflicts may have been found. Phase 2 further includes sub-phases or processes for: a) loading s values of the first set via an unaligned, masked load instruction into the vector val directly after and without overwriting values from the second set; b) finding conflicts in the vector val via a conflict-detection instruction; and c) writing back values for which a conflict has been found via a compress-and-store instruction.

Further, this algorithm fills up the vector val that is used for finding conflicts with K values in each iteration, i.e., |S2| values from the second set and K−|S2| values from the first set. This appears to be a major difference from other vectorized intersection algorithms, which, when values loaded from one set do not fill up a vector, load invalid values before an all-to-all comparison.

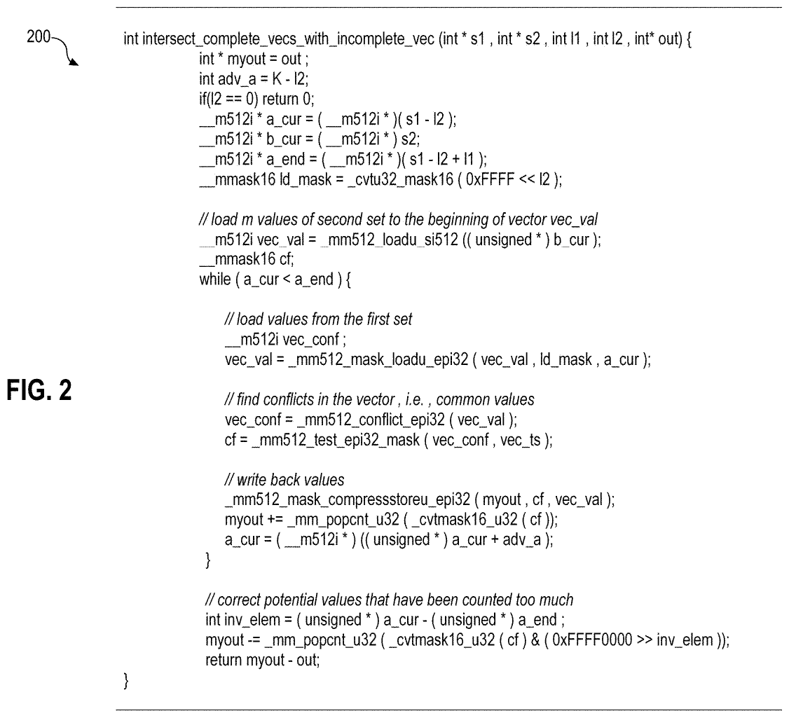

FIG. 2 illustrates pseudocode for an example vectorized sorted-set intersection algorithm for intersecting two sets, in which one set fits in half of a vector. The example algorithm is implemented as a function intersect_complete_vecs_with_incomplete_vec( ) which takes arguments or parameters s1, s2, l1, l2, and out. Argument s1 represents or holds values of a first set. Argument s2 represents or holds values of a second set. Arguments l1 and l2 specify or hold lengths of the sets s1 and s2, respectively. Argument out represents a result set that contains a number of common values of sets s1 and s2. In an example, argument out is a pointer to an array where the output should be written.

The function of FIG. 2 sets-up various variables, which include myout as a copy of out. The function later updates and uses myout to determine how many values are in the result set when the function completes (see return myout−out). The variable adv_a holds how many values are loaded from the first set in each iteration. The variables a_cur and b_cur are pointers to the current vector of the first and second input sets, respectively, and a_end is a pointer to the end of the first input set. There is only one vector for the second input set, and so a variable b_end is not needed.

The function adjusts a_cur and a_end by subtracting l2, and also advances a_end by adding l1, to load values of the first set always right after values of the second set in vec_val. As in the first example algorithm discussed above, the function uses the mask ld_mask, which depends on the length 12 of the second smaller set, to load the second set without overwriting values of the first set. After setting up the variables, the function loads the entire second set into vec_val via instruction mm512_loadu_si512. These values of the second set are loaded only once, which avoids unnecessary load operations.

In a while loop, the function iterates over the first larger set with a constant step size of adv_a. In each iteration, the function loads values from the first set via instruction _mm512_mask_loadu_epi32 using the load mask ld_mask to avoid overwriting values of the first set, finds conflicts between the first and second sets in the vector via instruction _mm512_conflict_epi32, and writes back common values via instruction _mm512 mask_compressstoreu_epi32. As for the function intersect incomplete vecs discussed above, the function intersect_complete_vecs_with_incomplete_vec uses in conflict mask cf a variable vec_ts, which is a vector with the replicated value 0xFFFFFFFF and is initialized outside of the function. The function increases myout by the number of common values found in an iteration, and updates pointer a_cur by the constant step size adv_a.

After leaving the while loop, the function compensates for invalid common values by adjusting myout. Invalid common values occur, for instance, in a last iteration of the function when there are invalid values loaded into the vector. For example, if 10 values are loaded from the first set in each iteration, but in a last iteration only 8 values remain in the first set, then 2 invalid values may have been loaded, and conflicts may be found based on the two invalid values. To compensate for this, the function calculates how many invalid values (inv_elem) may have been loaded in the last iteration by subtracting the actual length of the set a_end from the current length a_cur. The function updates myout by subtracting any conflicts found based on the values represented by inv_elem. To return the number of conflicts or common values, the function subtracts out from myout, which was initially set to out and then incremented for each counted conflict value.

Intersecting Two Sets where Each Set is Larger than Half of a Vector

According to an embodiment, the sorted-set intersection algorithm handles, and is invoked for, intersections where both sets have more than K/2 values. This algorithm works well for input sets of any size, and internally calls one of the other two algorithms discussed above when reaching an end of the input sets.

In this embodiment, the algorithm has two main phases. The algorithm performs, in a first phase, intersecting the sets as long as K/2 values can be loaded from each input set in each iteration. The first phase further includes: a) loading K/2 values from each input set into a single vector via an unaligned load instruction and an unaligned, masked load instruction; b) finding conflicts in the vector via a conflict-detection instruction; c) writing back values for which a conflict has been found via a compress-and-store instruction; and d) updating indices that point to the next values in each set based on the comparison of the last values of the currently loaded K/2 values from each set.

The algorithm performs, in a second phase, handling of remaining values at the end of the input sets. If the end of both sets has been reached because both inputs sets had a size that is a multiple of K/2, then the intersection is completed. If not, however, the second phase includes: a) if the remaining values of both sets are together less than or exactly K values, then invoking the first algorithm discussed above for sets that fit together in one vector and passing both sets to the first algorithm; b) if a second set has less than or exactly K/2 values left, then invoking the second algorithm discussed above where one set fits in half of a vector and with a first set passed as the first input set and the second set passed as the second input set; and c) if a first set has less than or exactly K/2 values left, then invoking second algorithm discussed above with the second set passed as the first input set and a first set passed as the second input set.

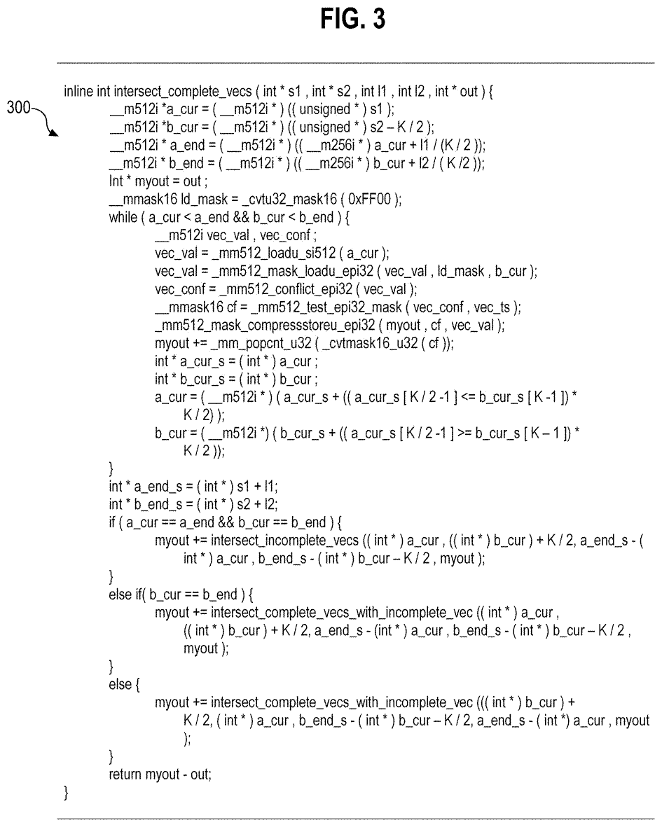

FIG. 3 illustrates pseudocode for an example vectorized sorted-set intersection algorithm for intersecting two sets, in which each set is larger than half of a vector. The example algorithm is implemented as an intersect_complete_vecs function, which takes arguments or parameters s1, s2, l1, l2, and out. Argument s1 represents or holds values of a first set. Argument s2 represents or holds values of a second set. Arguments l1 and l2 specify or hold lengths of the sets s1 and s2, respectively. Argument out represents a result set that contains a number of common values of sets s1 and s2. In an example, argument out is a pointer to an array where the output should be written.

The function includes an upper part with a while loop that performs intersection of inputs sets as long as K/2 current values can be loaded from each set in an iteration. In an embodiment, the upper part of the function loads K/2 values from each input set into one vector vec_val, finds common values via a conflict-detection instruction, writes back common values using a compressstore instruction to out, and updates indices that point to current values in both sets. The function leaves the while loop when the remaining values of at least one set are less than K/2.

The next lower part of the function handles intersection by invoking functions intersect incomplete vecs( ) (e.g., the first example algorithm related to FIG. 1) or intersect_complete_vecs_with_incomplete_vec( ) (e.g., the second example algorithm related to FIG. 2). As discussed above and illustrated by the example of FIG. 3, the lower part of the function invokes these functions depending on the number of remaining values that have not been processed by the upper part, that is, when one set has less than K/2 values or both sets have less than K values left to process.

Strategy Function for Selecting an Intersection Algorithm Based on the Size of the Input Sets

According to an embodiment, a strategy function is provided that is configured to select a function or algorithm implementation depending on arguments to the function, i.e., the size of input sets. Although, the function intersect_complete_vecs( ) of FIG. 3 already invokes the other two functions (the examples of FIGS. 1 and 2), there are technical reasons for implementing the present strategy function. For instance, the strategy function can be extended to include other algorithms, for instance, search-based intersection algorithms. Also, in application areas with many small sets, it may be beneficial to check for the most common case first, which would be when both input sets fit into one vector, and then to invoke the function intersect incomplete vecs. This would help to minimize branching overhead when small sets are more common than large sets.

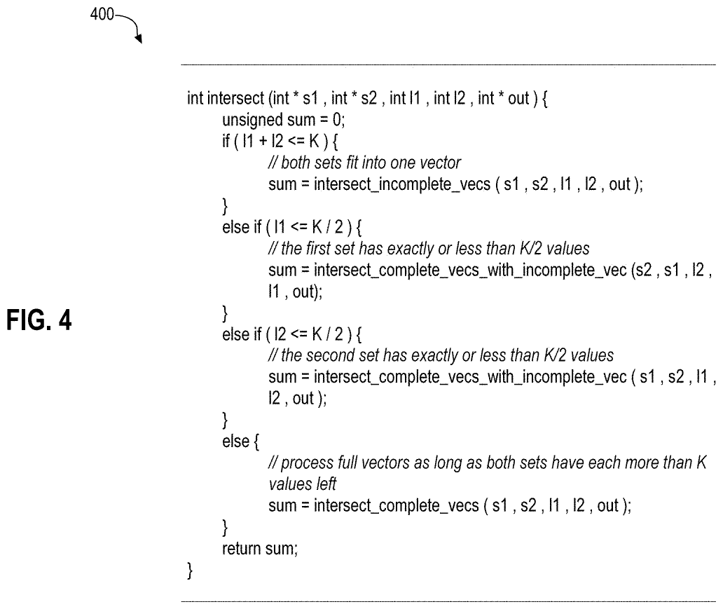

FIG. 4 illustrates pseudocode for an example strategy function intersect( ) The strategy function intersect( ) has the same function signature as the preceding intersection algorithms, i.e., the function takes two sets and their lengths, includes an output set, and returns the number of values that have been written to the output set. The strategy function has three branches which invoke, |depending on the size of the input sets, one of the functions proposed in this disclosure. The example strategy function of FIG. 4 first determines if both sets together fit in one vector, and if so, invokes the algorithm or function intersect incomplete vecs, as described above. If not, the strategy function determines if either set fits in half of a vector, and if so, invokes the algorithm or function intersect_complete_vecs_with_incomplete_vec. More particularly, if the first set fits in half of a vector, the strategy function passes, to the function intersect_complete_vecs_with_incomplete_vec, the second set as the first input set and the first set as the second input set. If the second set fits in half of a vector, the strategy function passes, to the function intersect_complete_vecs_with_incomplete_vec, the first set as the first input set and the second set as the second input set. Otherwise, the strategy function processes full vectors as long as both sets have each more than K values, and invokes the function inteserct complete_vecs.

Process Overview

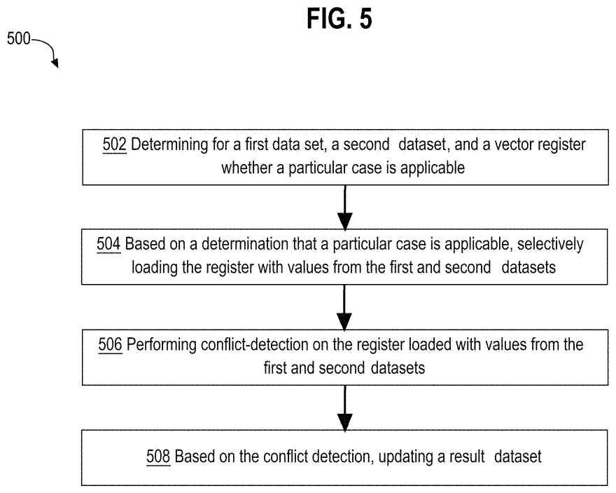

FIG. 5 illustrates a flow diagram that depicts a process for performing data intersection techniques and algorithms disclosed herein. Process 500 may be performed by a processor containing SIMD instruction sets, such as a processor configured with a x86 processor architecture.

At block 502, a processor determines for a first dataset, a second dataset, and a vector register, whether a particular case is applicable. In an example, the first dataset has a first number of values (e.g., a length 11), the second dataset has a second number of values (e.g., a length 12), and the vector register is configured to hold a third number of values (e.g., a size K).

In an embodiment, the processor determines at block 502 whether a first case is applicable, in which the first number of values in the first dataset and the second number of values in the second dataset total less than or equal to the third number of values of the vector register. In this first case, all the values of the first and second sets fit together into the vector register, which corresponds to the intersection algorithm details discussed above in the section—Intersecting Two Sets Fitting Together in One Vector.

The processor may determine at block 502 whether a second case is applicable, in which the first number of values in the first dataset and the second number of values in the second dataset total more than the third number of values of the vector register, and the first number of values in the first dataset or the second number of values in the second dataset is less than or equal to half of the third number of values of the vector register. In this second case, all the values of the first and second sets together do not fit into the vector register, but all of the values of one of the datasets fits into half of the vector register. This second case corresponds to the intersection algorithm details discussed above in the section—Intersecting Two Sets Where One Set Fits in Half of a Vector.

Further, the processor may determine at block 502 whether a third case is applicable, in which the first number of values in the first dataset and the second number of values in the second dataset total more than the third number of values of the vector register, and each of the first number of values in the first dataset and the second number of values in the second dataset is greater than half of the third number of values of the vector register. In this third case, all the values of the first and second sets together do not fit into the vector register, and each of the first set and the second set includes more values than half of the vector register. This third case corresponds to the intersection algorithm details discussed above in the section—Intersecting Two Sets Where Each Set is Larger than Half of a Vector.

At block 504, the processor loads the register with values from the first and second datasets. The processor, at block 504, selectively loads the register based on the determination of which particular case is applicable. At block 506, the processor performs conflict detection to identify conflicts or common values in the register loaded with values from first and second datasets. At block 508, the processors updates a result dataset based on the conflict detection at block 506.

If the processor determines at block 502 that the first case is applicable, the processor at block 504 loads the register with all the values of the first dataset and all the values of the second dataset. In this first case, at block 506, the processor performs conflict detection on the register including all the values from the first and second datasets, and the processor at block 508 updates a result dataset with results from the conflict detection. In this first case, the processor may also perform further processes discussed above in the section—Intersecting Two Sets Fitting Together in One Vector.

If the processor determines at block 502 that the second case is applicable, the processor at block 504 loads the register with all the values of the smaller set and a portion of the values of the larger set. At block 506, the processor performs conflict detection on the register including all the values from the smaller set and the portion of the values of the larger set. In this second case, the processor iterates through remaining portions of the larger set by loading the register with a next portion of the larger set and performing conflict detection on the register, which still includes all the values from the smaller set and now the next portion of the larger set. The processor at block 508 updates the result dataset after each iteration. In this second case, the processor may also perform further processes discussed above in the section—Intersecting Two Sets Where One Set Fits in Half of a Vector.

If the processor determines at block 502 that the third case is applicable, the processor at block 504 loads the register with a first portion of the values of the first set and a second portion of the values of the second set. In this case, each of the first portion of the first set and the second portion of the second set includes a number of values corresponding to half the size of the vector register, and at block 506, the processor performs conflict detection on the register loaded with these values. The processor iterates through the first and second sets by uploading next portions of each set corresponding to half the size of the register, and performing conflict detection until a last portion of the sets remains. For this last portion, the processor determines whether the first case or the second case is applicable based on remaining values of the first and second sets. If the first case is applicable based on the remaining values, the processor proceeds to process the remaining values as discussed above, for instance, according to the section—Intersecting Two Sets Fitting Together in One Vector. Otherwise, if the second case is applicable based on the remaining values, the processor proceeds to process the remaining values as discussed above, for instance, according to the section Intersecting Two Sets Where One Set Fits in Half of a Vector. In this third case, the processor may also perform further processes discussed above in the section—Intersecting Two Sets Where Each Set is Larger than Half of a Vector.

### Benefits and Applications

Several experiments were conducted showing that the vectorized sorted-set intersection algorithm using conflict-detection SIMD instructions and optimized for small and unpadded datasets, as disclosed herein, is significantly faster compared to scalar intersection algorithms and other vectorized intersection algorithms.

Experiments were conducted on a system that comprises an Intel i3-8121U CPU with a core frequency of up to 3.20 GHz and 8 GB of main memory. The CPU supports the following AVX-512 instruction sets: AVX512F, AVX512CD, AVX512BW, AVX512DQ, AVX512VL, AVX512IFMA, and AVX512VBMI. The employed SIMD instruction set operate on the 512-bit registers of AVX-512. Linux (kernel version 4.4.0) was used as the operating system. The algorithms are implemented in C++ and were compiled using GCC 5.4.0.

The disclosed vectorized intersection algorithm optimized for small and unpadded datasets (see FIG. 2 “pure-SIMD”), was compared with three other intersection algorithms. One of the other intersection algorithms is a scalar intersection algorithm that uses two branches in a main loop and compares one value of a first set with one value from a second set in each iteration. This scalar algorithm provides a baseline for performance comparison and speedups are calculated against this algorithm. Another of the intersection algorithms is a vectorized intersection algorithm (see FIG. 2 “mixed1-SIMD) composed of vectorized and scalar intersection algorithms and a compression algorithm, and is part of a C++ library available on github4. The third intersection algorithms is a mixed-SIMD set intersection algorithm (see FIG. 2 “mixed2-SIMD”) composed of vectorized and scalar intersection algorithms.

The experiments assessed the performance of the intersection algorithms by intersecting edge sets of graphs. The graphs were obtained from publicly available real-world graph datasets. For each dataset, the experiments intersected the edge set of each node with the edge set of each other node, i.e., performed a nested loop over the edge sets of all of the graph's nodes. When loaded in memory, the graphs for the datasets require from 50 MB up to around 0.5 GB of main memory. All intersections are run on a single core.

For each experiment, datasets were generated that consisted of uniformly distributed values that varied in selectivity, where selectivity is defined as the fraction of the number of common values of both ordered sets and the cardinality of the smaller set. The selectivity was varied by altering the domain of the values, where a greater domain leads to smaller selectivity and vice versa.

TABLE 1
Characteristics of the used real-world datasets

| | | | avg. edges | nodes with | nodes with |
|---|---|---|---|---|---|
| Dataset | # nodes | # edges | per node | ≤8 edges | >8 edges |
| D1 | 4,039 | 88,234 | 21.8 | 16.2% | 83.8% |
| D2 | 77,360 | 905,468 | 11.7 | 75.1% | 24.9% |
| D3 | 75,879 | 508,837 | 6.7 | 86.0% | 14.0% |
| D4 | 7,115 | 103,689 | 14.6 | 73.4% | 26.6% |
| D5 | 7,624 | 27,806 | 3.6 | 72.4% | 27.6% |
| D6 | 28,281 | 92,752 | 3.3 | 71.7% | 28.3% |
| D7 | 81,306 | 1,768,149 | 21.7 | 45.4% | 54.6% |

Table 1 illustrates the characteristics of seven datasets used for the experiments. Table 5 provides the number of nodes and edges for each dataset D1-D7, the average number of edges per node, and the percentage of how many edge sets have less than or exactly 8 values and how many have more than 8 values. The average number of edges per node is rather low. For three datasets, the average is below 8. Only two datasets have in average of more than 20 edges per node. This is one of the reasons that more than 70% of the nodes have edge sets with 8 or less values. For the dataset D3, even 86% of the nodes have edge sets with 8 or less values.

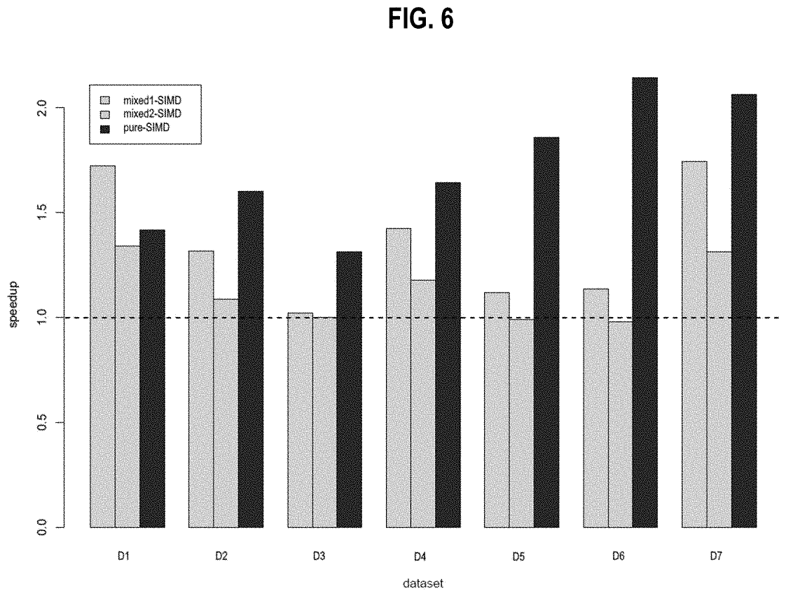

Results of the experiments are represented in FIG. 6, which illustrates speedups achieved by the three vectorized intersection algorithms mixed1-SIMD (first respective bar), mixed2-SIMD (second respective bar), and pure-SIMD (the disclosed vectorized intersection algorithm optimized for small, unpadded sets; third respective bar) on the datasets of Table 1. A higher speedup value in FIG. 6 represents a speedup in relation to the scalar intersection algorithm. As can be seen, the pure-SIMD algorithm is on all datasets, except on dataset D1, faster than the other two vectorized algorithms and the scalar algorithm. On datasets D5 and D6, the pure-SIMD algorithm achieves a speedup of 2-times compared to the scalar algorithm while the other two vectorized algorithms are only on par with the scalar algorithm.

The disclosed vectorized intersection algorithm may use a conflict-detection SIMD instruction implementation, which allows advancing in different speeds through two or more sorted sets and supports 32-bit and 64-bit values natively. This allows sophisticated iteration strategies for sorted sets with different sizes or different value domains. Furthermore, this implementation supports intersecting more than two sorted sets at a time and is beneficial for intersecting small sets with few elements (e.g., intersecting a sorted set with 60 values with a small, sorted set with 4 values).

The disclosed vectorized intersection algorithm can be implemented in a vast number of applications/products. Intersection, and in particular sorted-set intersection, is a fundamental operation and is used to some degree in many applications and systems. Applications where intersection is responsible for a large fraction of the overall runtime (certain queries and index creation in databases, various data mining algorithms, search index creation in information retrieval) would significantly benefit if the intersection algorithm is exchanged with the disclosed vectorized intersection algorithm. Hence, companies (e.g., Facebook, Microsoft, SAP, IBM, Google, Amazon) that process large amounts of data would be motivated to integrate the disclosed vectorized intersection algorithm in their products and applications.

The disclosed vectorized intersection algorithm can further be integrated into data structures and functions provided by various language libraries (e.g., std::set_intersection of the C++ standard template library). Programs using the data structures of these libraries would automatically benefit from the disclosed vectorized intersection algorithm. Similarly, the disclosed vectorized intersection algorithm may be integrated as a rule in just-in-time compilers, which then could detect and rewrite sort implementations during the runtime of a program. Even if the performance improvements are limited in programs that do not use intersection heavily, the cumulated performance improvements of the vast number of programs that benefit from the approach is substantial.

Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

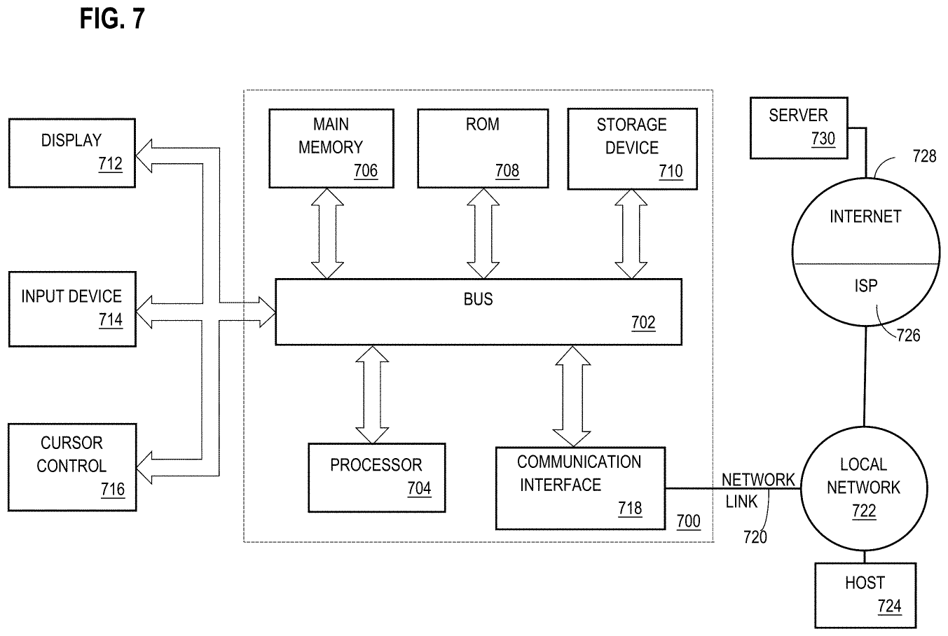

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general-purpose microprocessor.

Computer system 700 also includes a main memory 706, such as a random-access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

Software Overview

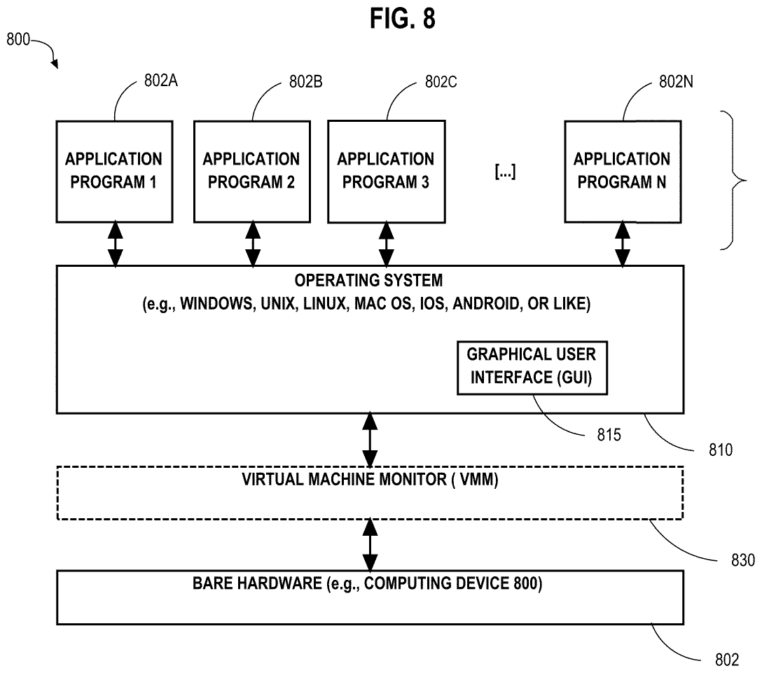

FIG. 8 is a block diagram of a basic software system 800 that may be employed for controlling the operation of computing system 700. Software system 800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 800 is provided for directing the operation of computing system 700. Software system 800, which may be stored in system memory (RAM) 706 and on fixed storage (e.g., hard disk or flash memory) 710, includes a kernel or operating system (OS) 810.

The OS 810 manages low-level aspects of computer operation, including managing execution of processes, memory allocation, file input and output (I/O), and device I/O. One or more application programs, represented as 802A, 802B, 802C . . . 802N, may be “loaded” (e.g., transferred from fixed storage 710 into memory 706) for execution by the system 800. The applications or other software intended for use on computer system 700 may also be stored as a set of downloadable computer-executable instructions, for example, for downloading and installation from an Internet location (e.g., a Web server, an app store, or other online service).

Software system 800 includes a graphical user interface (GUI) 815, for receiving user commands and data in a graphical (e.g., “point-and-click” or “touch gesture”) fashion. These inputs, in turn, may be acted upon by the system 800 in accordance with instructions from operating system 810 and/or application(s) 802. The GUI 815 also serves to display the results of operation from the OS 810 and application(s) 802, whereupon the user may supply additional inputs or terminate the session (e.g., log off).

OS 810 can execute directly on the bare hardware 820 (e.g., processor(s) 704) of computer system 700. Alternatively, a hypervisor or virtual machine monitor (VMM) 830 may be interposed between the bare hardware 820 and the OS 810. In this configuration, VMM 830 acts as a software “cushion” or virtualization layer between the OS 810 and the bare hardware 820 of the computer system 700.

VMM 830 instantiates and runs one or more virtual machine instances (“guest machines”). Each guest machine comprises a “guest” operating system, such as OS 810, and one or more applications, such as application(s) 802, designed to execute on the guest operating system. The VMM 830 presents the guest operating systems with a virtual operating platform and manages the execution of the guest operating systems.

In some instances, the VMM 830 may allow a guest operating system to run as if it is running on the bare hardware 820 of computer system 700 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830 for efficiency. In these instances, the guest operating system is “aware” that it executes on a virtual machine monitor. In other words, VMM 830 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### EXTENSIONS AND ALTERNATIVES

Although some of the figures described in the foregoing specification include flow diagrams with steps that are shown in an order, the steps may be performed in any order, and are not limited to the order shown in those flowcharts. Additionally, some steps may be optional, may be performed multiple times, and/or may be performed by different components. All steps, operations and functions of a flow diagram that are described herein are intended to indicate operations that are performed using programming in a special-purpose computer or general-purpose computer, in various embodiments. In other words, each flow diagram in this disclosure, in combination with the related text herein, is a guide, plan or specification of all or part of an algorithm for programming a computer to execute the functions that are described. The level of skill in the field associated with this disclosure is known to be high, and therefore the flow diagrams and related text in this disclosure have been prepared to convey information at a level of sufficiency and detail that is normally expected in the field when skilled persons communicate among themselves with respect to programs, algorithms and their implementation.

In the foregoing specification, the example embodiment(s) of the present invention have been described with reference to numerous specific details. However, the details may vary from implementation to implementation according to the requirements of the particular implement at hand. The example embodiment(s) are, accordingly, to be regarded in an illustrative rather than a restrictive sense.

What is claimed is:

1. A method, comprising:
determining, for a first dataset having a first number of values, a second dataset having a second number of values, and a register configured to hold a third number of values, whether:
a first case is applicable, in which the first number of values and the second number of values total less than or equal to the third number of values;
a second case is applicable, in which the first number of values and the second number of values total more than the third number of values, and the first number of values or the second number of values is less than or equal to half of the third number of values; or
a third case is applicable, in which the first number of values and the second number of values total more than the third number of values, and each of the first number of values and the second number of values is greater than half of the third number of values;
in response to a determination that the first case, the second case, or the third case is applicable, selectively loading to the register a first portion of the first dataset and a second portion of the second dataset;
performing a conflict-detection instruction for identifying one or more common values in the register loaded with the first portion and the second portion; and
based on performing the conflict-detection instruction, updating a result dataset.

2. The method of claim 1, further comprising:
wherein selectively loading to the register the first portion and the second portion comprises performing a single instruction, multiple data (SIMD) mask-load instruction; and
wherein performing the conflict-detection instruction further comprises performing a SIMD conflict-detection instruction;

3. The method of claim 1, further comprising:
creating a conflict mask for removing invalid values identified from performing the conflict-detection instruction; and
removing, using the conflict mask, the invalid values before updating the result dataset.

4. The method of claim 1, further comprising:
determining that the first case is applicable; and
in response to determining that the first case is applicable, the method further comprising loading to the register all values of the first dataset and all values of the second dataset.

5. The method of claim 4, further comprising:
determining that the first case is applicable, in which the first number of values and the second number of values total less than the third number of values; and
in response to determining that the first case is applicable, in which the first number of values and the second number of values total less than the third number of values, removing invalid common values in preparation of updating the result dataset.

6. The method of claim 1, further comprising:
determining that the second case is applicable, in which the second number of values is less than or equal to half of the third number of values;
in response to determining that the second case is applicable, the method further comprising:
loading to the register all values of the second dataset;
loading to the register the first portion of the first dataset directly after all values of the second dataset; and
performing the conflict-detection instruction for identifying one or more common values in the register loaded with all the values of the second dataset and the first portion of the first dataset.

7. The method of claim 6, further comprising:
determining that the second case is applicable, wherein the second number of values is less than or equal to half of the third number of values;
in response to determining that the second case is applicable, wherein the second number of values is less than or equal to half of the third number of values, the method further comprising:
updating a pointer to the first dataset to correspond to a third portion of the first dataset;
loading to the register the third portion directly after all values of the second dataset; and
performing the conflict-detection instruction for identifying one or more common values in the register loaded with all the values of the second dataset and the third portion of the first dataset.

8. The method of claim 7, further comprising removing invalid conflicts in preparation of updating the result dataset.

9. The method of claim 1, further comprising:
determining that the third case is applicable;
in response to determining that the third case is applicable, the method further comprising:
loading the register with the first portion of the first dataset and the second portion of the second dataset, wherein each of the first portion of the first dataset and the second portion of the second dataset includes a number of values corresponding to half of the third number of values; and
performing the conflict-detection instruction for identifying one or more common values in the register loaded with the first portion and the second portion.

10. The method of claim 9, further comprising:
determining that the third case is applicable;
in response to performing the conflict-detection instruction for identifying one or more common values in the register loaded with the first portion and the second portion, the method further comprising:
determining, for a third portion of the first dataset having a fourth number of values and a fourth portion of the second dataset having a fifth number of values, whether:
a fourth case is applicable, in which the third number of values and the fourth number of values total less than or equal to the third number of values; or
a fifth case is applicable, in which the third number of values and the fourth number of values total more than the third number of values, and the third number of values or the fourth number of values is less than or equal to half of the third number of values;
in response to a determination that the fourth case or the fifth case is applicable, selectively loading to the register the third portion and the fourth portion; and
performing the conflict-detection instruction for identifying one or more common values in the register loaded with the third portion and the fourth portion.

11. One or more non-transitory computer-readable storage medium storing instructions that, when executed by one or more processors, cause the one or more processors to perform functions comprising:
determining, for a first dataset having a first number of values, a second dataset having a second number of values, and a register configured to hold a third number of values, whether:
a first case is applicable, in which the first number of values and the second number of values total less than or equal to the third number of values;
a second case is applicable, in which the first number of values and the second number of values total more than the third number of values, and the first number of values or the second number of values is less than or equal to half of the third number of values; or
a third case is applicable, in which the first number of values and the second number of values total more than the third number of values, and each of the first number of values and the second number of values is greater than half of the third number of values;
in response to a determination that the first case, the second case, or the third case is applicable, selectively loading to the register a first portion of the first dataset and a second portion of the second dataset;
performing a conflict-detection instruction for identifying one or more common values in the register loaded with the first portion and the second portion; and
based on performing the conflict-detection instruction, updating a result dataset.

12. The one or more non-transitory computer-readable storage medium of claim 11, wherein the functions further comprise:
selectively loading to the register the first portion and the second portion by performing a single instruction, multiple data (SIMD) mask-load instruction; and
performing the conflict-detection instruction by performing a SIMD conflict-detection instruction;

13. The one or more non-transitory computer-readable storage medium of claim 11, wherein the functions further comprise:
creating a conflict mask for removing invalid values identified from performing the conflict-detection instruction; and
removing, using the conflict mask, the invalid values before updating the result dataset.

14. The one or more non-transitory computer-readable storage medium of claim 11, wherein the functions further comprise:
determining that the first case is applicable; and
in response to determining that the first case is applicable, loading to the register all values of the first dataset and all values of the second dataset.

15. The one or more non-transitory computer-readable storage medium of claim 14, wherein the functions further comprise:
determining that the first case is applicable, in which the first number of values and the second number of values total less than the third number of values; and
in response to determining that the first case is applicable, in which the first number of values and the second number of values total less than the third number of values, removing invalid common values in preparation of updating the result dataset.

16. The one or more non-transitory computer-readable storage medium of claim 11, wherein the functions further comprise:
determining that the second case is applicable, in which the second number of values is less than or equal to half of the third number of values;
in response to determining that the second case is applicable:
loading to the register all values of the second dataset;
loading to the register the first portion of the first dataset directly after all values of the second dataset; and
performing the conflict-detection instruction for identifying one or more common values in the register loaded with all the values of the second dataset and the first portion of the first dataset.

17. The one or more non-transitory computer-readable storage medium of claim 16, wherein the functions further comprise:
determining that the second case is applicable, wherein the second number of values is less than or equal to half of the third number of values;
in response to determining that the second case is applicable, wherein the second number of values is less than or equal to half of the third number of values:
updating a pointer to the first dataset to correspond to a third portion of the first dataset;
loading to the register the third portion directly after all values of the second dataset; and
performing the conflict-detection instruction for identifying one or more common values in the register loaded with all the values of the second dataset and the third portion of the first dataset.

18. The one or more non-transitory computer-readable storage medium of claim 17, wherein the functions further comprise removing invalid conflicts in preparation of updating the result dataset.

19. The one or more non-transitory computer-readable storage medium of claim 11, wherein the functions further comprise:
determining that the third case is applicable;
in response to determining that the third case is applicable:
loading the register with the first portion of the first dataset and the second portion of the second dataset, wherein each of the first portion of the first dataset and the second portion of the second dataset includes a number of values corresponding to half of the third number of values; and
performing the conflict-detection instruction for identifying one or more common values in the register loaded with the first portion and the second portion.

20. The one or more non-transitory computer-readable storage medium of claim 19, wherein the functions further comprise:
determining that the third case is applicable;
in response to performing the conflict-detection instruction for identifying one or more common values in the register loaded with the first portion and the second portion:
determining, for a third portion of the first dataset having a fourth number of values and a fourth portion of the second dataset having a fifth number of values, whether:
a fourth case is applicable, in which the third number of values and the fourth number of values total less than or equal to the third number of values; or
a fifth case is applicable, in which the third number of values and the fourth number of values total more than the third number of values, and the third number of values or the fourth number of values is less than or equal to half of the third number of values;
in response to a determination that the fourth case or the fifth case is applicable, selectively loading to the register the third portion and the fourth portion; and
performing the conflict-detection instruction for identifying one or more common values in the register loaded with the third portion and the fourth portion.
